(19) United States
(12) Patent Application Publication
(10) Pub. No.: US 2008/0074694 A1
(43) Pub. Date: Mar. 27, 2008

(54) IMAGE PROCESSING APPARATUS

(75) Inventor: Yukihiro SAIDA, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 11/859,282

(22) Filed: Sep. 21, 2007

(30) Foreign Application Priority Data
Sep. 25, 2006 (JP) 2006-259521

(51) Int. Cl. G06F 3/12

(52) U.S. Cl. 358/1.15

(57) ABSTRACT

The present invention is an information processing apparatus that can make a judgment as to whether there is a difference between user print setting information and print setting information through the comparison of the user print setting information stored in a user print setting information storage unit and the print setting information acquired by a print setting information acquisition unit performed by a print setting information comparison unit. In a case where a judgment is made by the print setting information comparison unit that there is a difference, the display unit displays notification that there is a difference between the print setting information and the user print setting information. Accordingly, it is not necessary for the user to confirm each field of the print setting information every time, and the user does not overlook a difference in the setting.

### BACKGROUND OF THE INVENTION

1. Field of the Invention

The present invention relates to an image processing apparatus that receives a print job from an application and generates printing data.

2. Description of Related Art

Conventionally, in image processing apparatuses that receive a print job from an application and generates printing data, where there is a print command from a user, a confirmation screen for confirming printing information of the print job set by the application, such as a file name, number of printed pages, number of printed copies, color or black and white printing, or the like, and printing is initiated by the user pushing a printing initiation button on the confirmation screen. Furthermore, in a case where the user makes an error in the print setting information, the print job can be deleted by the user pushing a cancel button on the confirmation screen (see, e.g., Japanese Unexamined Patent Application Publication No. 2005-182396).

In the image processing apparatus such as that of Japanese Unexamined Patent Application Publication No. 2005-182396, however, the user must confirm each field of the print setting information, confirm whether there is an error, and accept the confirmations every time, so that there is a problem of being troublesome for the user.

### SUMMARY OF THE INVENTION

It is an objective of the present invention to provide an image processing apparatus that can decrease a burden placed on a user by eliminating the need for confirming print setting information of a print job every time.

According to one aspect of the invention, an image processing apparatus generates printing data based on a received print job and contains a user print setting information input unit for inputting user print setting information set for each user, a user print setting information storage unit for storing the user print setting information input by the user print setting information input unit, a print setting information acquisition unit for acquiring the print setting information from the print job, a print setting information comparison unit for making a comparison between the user print setting information stored in the user print setting information storage unit and the print setting information acquired by the print setting information acquisition unit, and a display unit for displaying notification that there is a difference between the user print setting information and the print setting information in a case where a result of the comparison by the print setting information comparison unit is that there is a difference between the user print setting information and the print setting information.

The image processing apparatus according to the above aspect of the present invention can make a judgment as to whether there is a difference between the user print setting information and the print setting information through the comparison of the user print setting information stored in the user print setting information storage unit and the print setting information acquired by the print setting information acquisition unit performed by the print setting information comparison unit. In a case where a judgment is made by the print setting information comparison unit that there is a difference, the display unit displays notification that there is a difference between the print setting information and the user print setting information. Accordingly, it is not necessary for the user to confirm each field of the print setting information every time, and also the user does not overlook a difference in the setting.

### BRIEF DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein:

FIG. 1 is a block diagram showing a structure of the image processing apparatus according to a first embodiment of the invention;

FIG. 2 is a diagram showing an example of a page setting screen of the image processing apparatus according to the first embodiment of the invention;

FIG. 3 is a diagram showing an example of a print setting screen of the image processing apparatus according to the first embodiment of the invention;

FIG. 4 is a diagram showing an example of a confirmation screen of the image processing apparatus according to the first embodiment of the invention;

FIG. 5 is a flow chart showing steps of a comparison process by a print setting information comparison unit of the image processing apparatus according to the first embodiment of the invention;

FIG. 6 is a flow chart showing steps of a display process by a confirmation screen display unit of the image processing apparatus according to the first embodiment of the invention;

FIG. 7 is a flow chart showing steps of the comparison process by the print setting information comparison unit of the image processing apparatus according to a second embodiment of the invention;

FIG. 8 is a flow chart showing steps of the display process by the confirmation screen display unit of the image processing apparatus according to the second embodiment of the invention;

FIG. 9 is a diagram showing an example of the confirmation screen of the image processing apparatus according to the second embodiment of the invention;

FIG. 10 is a flow chart showing steps of the display process by the confirmation screen display unit of the image processing apparatus according to a third embodiment of the invention;

FIG. 11 is a diagram showing an example of the confirmation screen of the image processing apparatus according to the third embodiment of the invention;

FIG. 12 is a block diagram showing the structure of the image processing apparatus according to a fourth embodiment of the invention;

FIG. 13 is a diagram showing an example of the confirmation screen of the image processing apparatus according to the fourth embodiment of the invention;

FIG. 14 is a flow chart showing steps of the comparison process by the print setting information comparison unit of the image processing apparatus according to the fourth embodiment of the invention; and

FIG. 15 is a flow chart showing steps of the display process by the confirmation screen display unit of the image processing apparatus according to the fourth embodiment of the invention.

### PREFERRED EMBODIMENTS

The following is a description of the image processing apparatus according to the present invention, referencing diagrams. The image processing apparatus according to the present invention is not limited to the following description, and can be arbitrarily modifiedd without departing from a general scope of the invention.

### First Embodiment

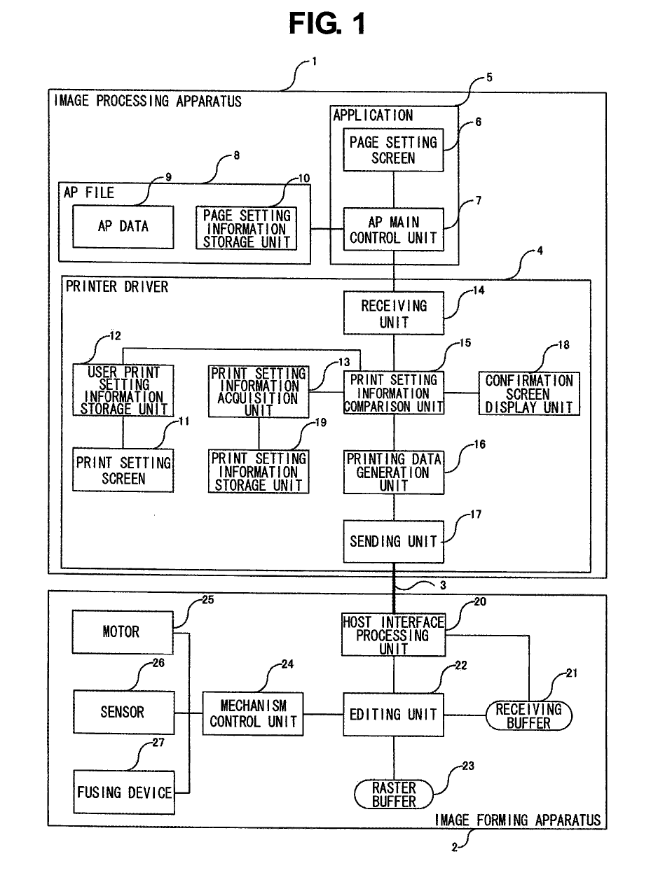

FIG. 1 is a block diagram showing an example of an image forming system including the image processing apparatus according to the present invention. An image processing apparatus 1 according to the present invention, described as a first embodiment, is connected to an image forming apparatus 2 via a USB (Universal Serial Bus). The image forming apparatus 2 generates image data based on the printing data sent from the image processing unit 1.

The image processing unit 1 is composed of a printer driver 4, an application 5, and an application file 8 (hereinafter referred to as “AP file”)).

The AP file 8 is stored in a storage apparatus, not shown, such as a hard disk or the like of the image processing apparatus 1. The AP file 8 is composed of application data 9 (hereinafter referred to as “AP data”) and a page setting information storage unit 10. The AP data 9 is a data portion of the AP file 8. Furthermore, the page setting information storage unit 10 stores the print setting information of the application 5.

The application 5 is composed of a page setting screen 6 and an application main control section 7 (hereinafter referred to as “AP main control section”), and is a common software program for creating texts and images.

The AP main control section 7 is a control section controlling the entire application. Furthermore, the AP main control section 7 displays an image in a display of the image processing apparatus 1 based on the AP file 8 and, in a case where the image data is edited, writes the information of the edited image data into the AP file 8.

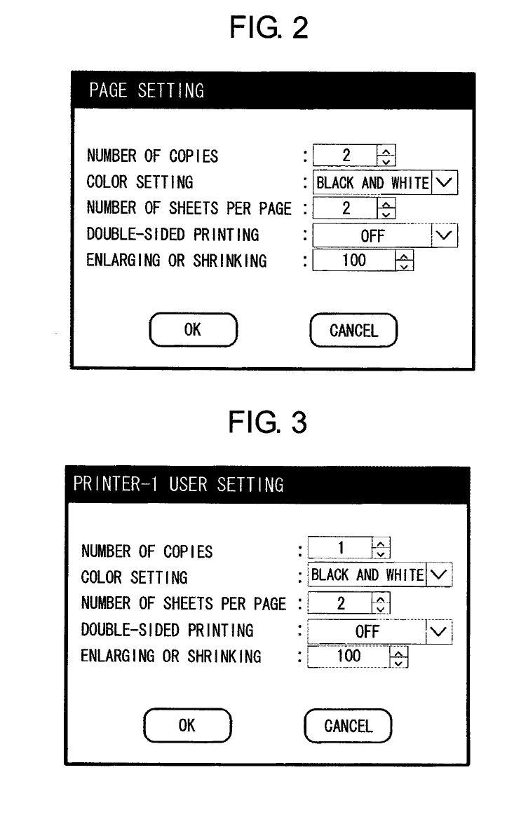

The page setting screen 6 is a setting screen for changing the print setting information of the page setting information storage unit 10 of the AP file 8, and is displayed in the display of the image processing apparatus 1. The page setting screen 6 is, for example, a type of screen as shown in FIG. 2, and can set the print setting information of the print job by selecting each field in the screen such as number of copies printed, color setting, number of pages per sheet, double-sided printing, enlarging or shrinking, and the like. Each field contains selectable information, which is setting information that can be selected for each field, and the setting of each field is selected from the selectable information. For example, the field for number of copies printed contains the selectable information as to the number of copies, such as one copy and two copies from which the number of copies printed is selected. Furthermore, the selectable information in the field for color setting is black and white or color, the selectable information in the field for the number of pages per sheet is the number of pages such as one page, two pages and four pages, the selectable information in the field for double-sided printing is on or off, and the selectable information in the field for enlarging or shrinking is an enlarging ratio or a shrinking ratio such as 200%, 100%, and 50%.

By pressing an OK button of the page setting screen 6, each selected field is set as the print setting information of the print job, and the page setting screen 6 is closed. Furthermore, by pressing the cancel button of the page setting screen 6, each selected field is ignored, and the page setting screen 6 is closed. For example, by pressing the OK button in the page setting screen 6 shown in FIG. 2, the print setting information is set such that the number of copies setting is two copies, the color setting is black and white, the number of pages per sheet setting is two pages per sheet, the double-sided printing setting is off, and the enlarging or shrinking setting is 100%.

The printer driver 4 is composed of a print setting screen 11 functioning as a user print setting information input unit, a user print setting information storage unit 12, a print setting information acquisition unit 13, a receiving unit 14, a print setting information comparison unit 15, a printing data generation unit 16, a sending unit 17, a confirmation screen display unit 18 serving as a display unit, and a print setting information storage unit 19.

The receiving unit 14 receives the print job output from the application 5.

The print setting screen 11 is a setting screen through which the user print setting information set for each user is input, and is displayed in the display of the image processing apparatus 1. The print setting screen 11 is, for example, the setting screen shown in FIG. 3, and can set the user print setting information of an individual user by selecting each field in the screen, such as number of copies printed, color setting, number of pages per sheet, double-sided printing, enlarging or shrinking, and the like. Each field contains selectable information, which is setting information that can be selected for each field, and the setting of each field is selected from the selectable information. For example, the field for number of copies printed contains the selectable information as to the number of copies, such as one copy and two copies. Furthermore, the selectable information in the field for color setting is black and white or color, the selectable information in the field for the number of pages per sheet is one page, two pages, four pages, and the like, the selectable information in the field for double-sided printing is on or off, and the selectable information in the field for enlarging or shrinking is an enlarging ratio or a shrinking ratio such as 200%, 100%, and 50%.

By pressing an OK button of the print setting screen 11, each selected field is set as the user print setting information of the individual user, and the print setting screen 11 is closed. Furthermore, by pressing the cancel button of the print setting screen 11, each selected field is ignored, and the print setting screen 11 is closed. For example, by pressing the OK button in the print setting screen 11 shown in FIG. 3, the user print setting information is set such that the number of copies setting is one copy, the color setting is black and white, the number of pages per sheet setting is two pages per sheet, the double-sided printing setting is off, and the enlarging or shrinking setting is 100%. The user print setting information is set via the print setting screen 11 before the print job is sent. The user print setting information storage unit 12 stores the user print setting information set through the print setting screen 11.

The print setting information acquisition unit 13 retrieves the print setting information set by the application 5 from the print job.

The print setting information storage unit 19 stores the print setting information retrieved by the print setting information acquisition unit 13 from the print job.

The print setting information comparison unit 15 compares the user print setting information stored in the user print setting information storage unit 12 with the print setting information stored in the print setting information storage unit 19.

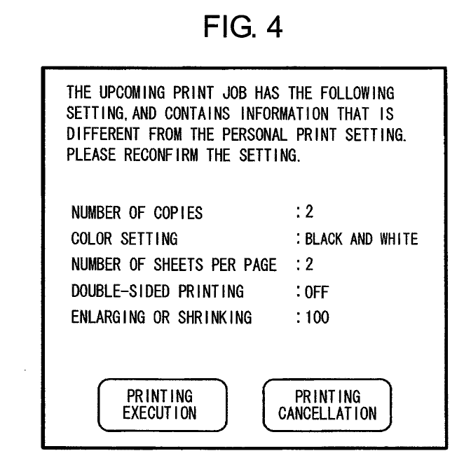

The confirmation screen display unit 18, in a case where the comparison by the print setting information comparison unit 15 indicates a difference between the user print setting information and the print setting information, displays the confirmation screen in the display of the image processing apparatus 1 by a display process for displaying the status that there is a difference between the user print setting information and the print setting information. The confirmation screen display unit 18 displays, for example, the confirmation screen shown in FIG. 4, thereby reporting to the user the status that a difference exists and the print setting information set by the application 5. By pressing a printing execution button of the confirmation screen, printing is executed based on the displayed print setting information and the confirmation screen is closed. Furthermore, by pressing a printing cancellation button of the confirmation screen, printing based on the print job containing the aforementioned print setting information is cancelled.

The printing data generation unit 16, based on the set print setting information, converts the print job output from the application 5 into printing data that can be analyzed by the image forming apparatus 2.

The sending unit 17 sends the printing data generated by the printing data generation unit 16 to the image forming apparatus 2 via the USB.

The image forming apparatus 2 is composed of a host interface processing unit 20, a receiving buffer 21, an editing unit 22, a raster buffer 23, a mechanism control unit 24, a motor 25, a sensor 26, and a fusion device 27.

The host interface processing unit 20 is connected to an interface of the image processing apparatus 1 and receives the printing data sent via the USB 3 from the sending unit 17 of the printer driver 4 of the image processing apparatus 1. The host interface processing unit 20 then notifies the editing unit 22 that the printing data is received.

The receiving buffer 21 stores the printing data received by the host interface processing unit 20. The stored printing data is sent to the editing unit to be converted into image data.

The editing unit 22, upon receiving notification that the host interface processing unit 20 received the printing data, rasterizes the printing data stored in the receiving buffer 21 into image data such as bitmap data, based on which the image can be formed under control of the mechanism control unit 24, thereby converting the printing data through rasterization into the image data on a single page basis.

The raster buffer 23 stores the image data converted by the editing unit 22 on a single page basis. The stored image data is sent to the mechanism control unit 24 to form the image on a printing medium.

The mechanism control unit 24, upon receiving the printing command from the editing unit 22, controls the motor 25, the sensor 26, and the fusion device 27 to form the image on the printing medium based on the image data converted by the editing unit 22 and stored in the raster buffer 23.

Specifically, the mechanism control unit 24 drives the motor 25 and the sensor 26, forms an electrostatic latent image on an image drum by exposure or the like based on the image information of the scanned image, and affixes toner to the image drum. The mechanism control unit 24 then forms the image by transferring the toner affixed on the image drum to the printing medium. The mechanism control unit 24 controls the fusion device 27 to fuse the image transferred to the printing medium onto the printing medium and the printing medium and discharges the printing medium on which the image is formed to an outside of the image forming apparatus 2.

The image processing apparatus 1 structured as described above performs in the following manner.

First, the user activates the application 5 of the image processing apparatus 1 and, upon opening of the AP file 8, the AP main control unit 7 reads from the AP file 8 the AP data 9 and the print setting information of the page setting information storage unit 10. The AP main control unit 7 then displays the read print setting information in the display of the image processing apparatus 1. In a case where the user changes the displayed print setting information, the AP main control unit 7 displays the page setting screen 6 so that the user changes the print setting information via the displayed page setting screen 6, and the changed setting becomes the print setting information of the print job.

Where the user gives a print command to the application 5, the AP main control unit 7 generates the print job based on the AP data 9 and the print setting information of the page setting information storage unit 10 or the print setting information changed via the page setting screen 6. The AP main control unit 7 then sends the generated print job to the printer driver 4.

The printer driver 4 receives the print job from the application 5 via the receiving unit 14. The receiving unit sends the received print job to the print setting information comparison unit 15. The print setting information comparison unit 15 receives the print job and, as described hereinafter, performs a comparison process between the print setting information and the user print setting information.

The comparison process of the print setting information is performed and, in a case where the print setting information comparison unit 15 makes a judgment that the printing is cancelled, the print setting information comparison unit 15 deletes the print job. On the other hand, in a case where the print setting information comparison unit 15 makes a judgment that the printing is performed, the print setting information comparison unit 15 sends the print job to the printing data generation unit 16.

The printing data generation unit 16 converts the received print job into printing data that can be analyzed by the image forming apparatus 2 and sends the converted printing data to the sending unit 17. The sending unit 17 receives the printing data converted by the printing data generation unit 16 and sends the printing data to the image forming apparatus 2.

The image forming apparatus 2 receives the printing data sent from the printer driver 4 of the image processing apparatus 1 through the host interface processing unit 20. The host interface processing unit 20 stores the received printing data in the receiving buffer 21 and notifies the editing unit 22 that the printing data is received.

The editing unit 22 receives the notification and reads the received printing data from the receiving buffer 21. The editing unit 22 then converts the read printing data into image data based on which the image can be formed. The editing unit 22 stores the converted data in the raster buffer 23. After image data corresponding to a single page is converted, the editing unit 22 then notifies the mechanism control unit 24 of the command to initiate printing.

The mechanism control unit 24 acquires the image data from the editing unit 22 and controls the motor 25, the sensor 26, and the fusion device 27 to generate the image on the printing medium based on the image data.

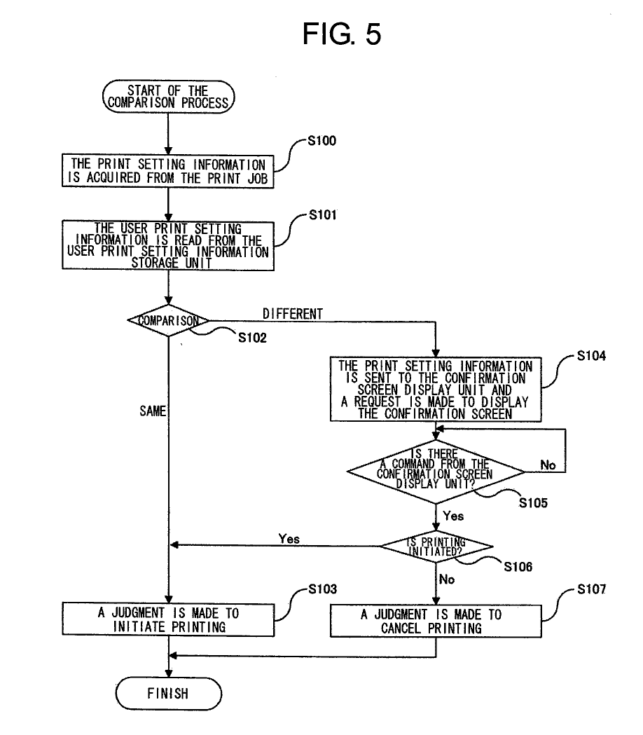

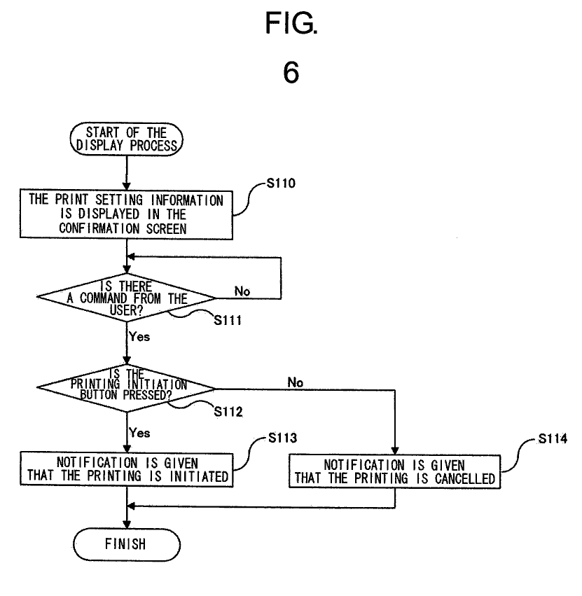

Next, the comparison process of the print setting information by the print setting information comparison unit 15 and the display process of the confirmation screen by the confirmation screen display unit 18 are described referencing FIGS. 5 and 6. FIG. 5 is a flow chart of the comparison process between the print setting information and the user print setting information by the print setting information comparison unit 15. FIG. 6 is a flow chart of the display process of the confirmation screen by the confirmation screen display unit.

As described above, upon receiving the print job, the print setting information comparison unit 15 performs the comparison process between the print setting information and the user print setting information according to the steps shown in FIG. 5.

The print setting information comparison unit 15 sends the received print job to the print setting information acquisition unit 13. The print setting information acquisition unit 13 retrieves the print setting information from the received print job. For example, in a case where print setting information such as that of the page setting screen 6 of FIG. 2 is set, the print setting information acquisition unit 13 retrieves, as the print setting information, print setting information wherein the number of copies setting is two copies, the color setting is black and white, the number of pages per sheet setting is two pages per sheet, the double-sided printing setting is off, and the enlarging or shrinking setting is 100%. The print setting information acquisition unit 13 stores the retrieved print setting information in the print setting information storage unit 19. The print setting information acquisition unit 13 then sends the print setting information stored in the print setting information storage unit 19 to the print setting information comparison unit 15. The print setting information comparison unit 15, at step S100, acquires the print setting information from the print setting information acquisition unit 13.

The print setting information comparison unit 15 receives the print setting information and, at step S101, reads from the user print setting information storage unit 12 the user print setting information stored therein having been input via the print setting screen 11 before the print job is sent. For example, in a case where user print setting information such as that of the print setting screen 11 of FIG. 3 is set, the print setting information comparison unit 15 retrieves, as the user print setting information, user print setting information wherein the number of copies setting is one copy, the color setting is black and white, the number of pages per sheet setting is two pages per sheet, the double-sided printing setting is off, and the enlarging or shrinking setting is 100%.

The print setting information comparison unit 15 reads the print setting information and, at step S102, compares the print setting information acquired from the print setting information acquisition unit 13 and the user print setting information read from the user print setting information storage unit 12.

In a case where a result of the comparison by the print setting information comparison unit 15 at step S102 is that the print setting information and the user print setting information are the same, the print setting information comparison unit 15, at step S103, makes a judgment to initiate printing, thereby finishing the comparison process. The print setting information comparison unit 15 then sends the print job to the printing data generation unit 16 so that the printing data can be generated based on the received print job.

On the other hand, in a case where a result of the comparison by the print setting information comparison unit 15 at step S102 is that the print setting information and the user print setting information are not the same, the print setting information comparison unit 15, at step S104, sends the print setting information to the confirmation screen display unit 18 and requests execution of the display process of the confirmation screen. Then, at step S105, the print setting information comparison unit 15 stands by until receiving a response from the confirmation screen display unit 18.

In the manner described above, where the print setting information comparison unit 15 requests performance of the display process of the confirmation screen to the confirmation screen display unit 18, the confirmation screen display unit 18 performs the display process of the confirmation screen according to the steps shown in FIG. 6.

Upon receiving the request for the display process of the confirmation screen from the print setting information comparison unit 15, the confirmation screen display unit 18, at step S110, displays notification that there is a difference between the print setting information and the user print setting information, and also displays the print setting information acquired by the print setting information acquisition unit 13, as the confirmation screen such as that shown in FIG. 4, in the display of the image processing apparatus 1.

At step S111, the confirmation screen display unit 18 stands by until the user presses one of either the printing execution button or the printing cancellation button to issue a command regarding the print job. After receiving a response from the user, the confirmation screen display unit 18, at step S112, makes a judgment as to whether the printing execution button is pushed.

At step S112, in a case where the printing execution button is pushed, the confirmation screen display unit 18, at step S113, notifies the print setting information comparison unit 15 of a response to initiate printing, thereby finishing the display process. On the other hand, in a case where the printing cancellation button is pushed at step S112, the confirmation screen display unit 18, at step S114, notifies the print setting information comparison unit 15 of a response to cancel printing, thereby finishing the display process.

As shown in step S105 of FIG. 5, upon receiving notification of the response from the confirmation screen display unit 18, the print setting information comparison unit 15, at step S106, makes a judgment as to whether the notification is the response to initiate printing.

In a case where the result of the judgment at step S106 is that the print setting information comparison unit 15 receives notification of the response to initiate printing, the print setting information comparison unit 15, at step S103, makes a judgment to initiate printing, thereby finishing the comparison process. The print setting information comparison unit 15 then sends the print job to the printing data generation unit 16 to generate the printing data based on the received print job.

On the other hand, in a case where the result of the judgment at step S106 is that the print setting information comparison unit 15 receives notification of the response to cancel printing, the print setting information comparison unit 15, at step S107, makes a judgment to cancel printing and deletes the print job, thereby finishing the comparison process.

In the manner described above, through the comparison process by the print setting information comparison unit 15, the image processing apparatus 1 described as the first embodiment can make a judgment as to whether there is a difference between the user print setting information stored in the user print setting information storage unit 12 and the print setting information of the print job acquired by the print setting information acquisition unit 13, by making a comparison therebetween. In a case where a judgment is made by the print setting information comparison unit 15 that there is a difference, a display notifying that there is a difference between the user print setting information and the print setting information is displayed by the confirmation screen display unit 18 as the confirmation screen. Accordingly, the user is not required to confirm each field of the print setting information every time, and furthermore, a difference in the settings is no longer overlooked.

In addition, by displaying the print setting information as well as the display notifying that there is a difference between the user print setting information and the print setting information, a judgment can be made as to whether to initiate printing based on the displayed print setting information. That is, even where the print setting information and the user print setting information are different, printing based on the print job can be executed.

### Second Embodiment

The image processing apparatus 1 described in a second embodiment has the same structure as that of the first embodiment, but the comparison process by the print setting information comparison unit 15 and the display process by the confirmation screen display unit 18 are different in that, along with notification that there is a difference between the print setting information and the user print setting information, only a field of the print setting information that is different is displayed. In addition, because the image processing apparatus 1 described in the second embodiment has the same structure as that of the first embodiment, the same numerals are used for the same parts and the description is omitted.

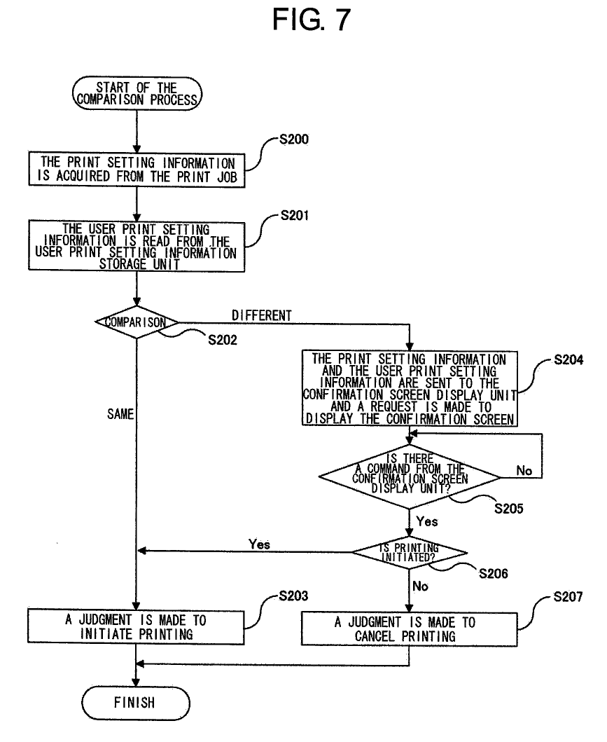

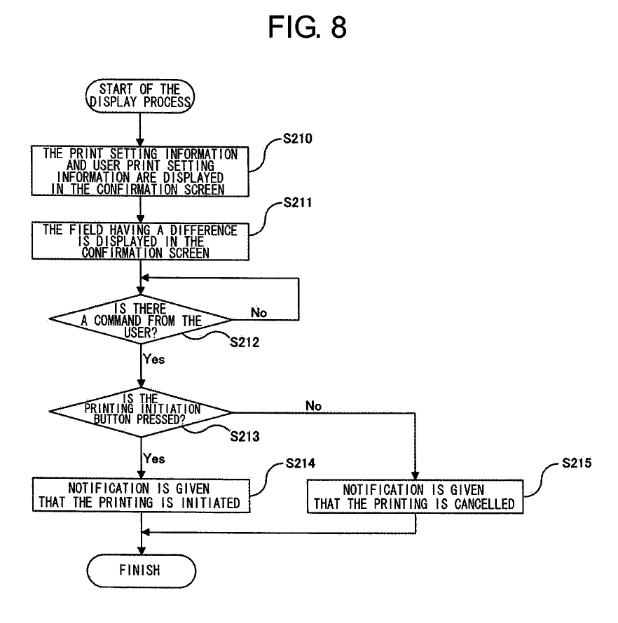

The comparison process of the print setting information by the print setting information comparison unit 15 and the display process of the confirmation screen by the confirmation screen display unit 18 in the image processing apparatus 1 described in the second embodiment are described referencing FIG. 7 and FIG. 8. FIG. 7 is a flow chart of the comparison process between the print setting information and the user print setting information by the print setting information comparison unit 15. FIG. 8 is a flow chart of the display process of the confirmation screen by the confirmation screen display unit.

In the same manner as the first embodiment, upon receiving the print job, the print setting information comparison unit 15 performs the comparison process between the print setting information and the user print setting information according to the steps shown in FIG. 7.

The print setting information comparison unit 15 sends the received print job to the print setting information acquisition unit 13. The print setting information acquisition unit 13 retrieves the print setting information from the received print job. For example, in a case where print setting information such as that of the page setting screen 6 of FIG. 2 is set, the print setting information acquisition unit 13 retrieves, as the print setting information, print setting information wherein the number of copies setting is two copies, the color setting is black and white, the number of pages per sheet setting is two pages per sheet, the double-sided printing setting is off, and the enlarging or shrinking setting is 200%. The print setting information acquisition unit 13 stores the retrieved print setting information in the print setting information storage unit 19. The print setting information acquisition unit 13 then sends the print setting information stored in the print setting information storage unit 19 to the print setting information comparison unit 15. The print setting information comparison unit 15, at step S200, acquires the print setting information from the print setting information acquisition unit 13.

The print setting information comparison unit 15 receives the print setting information and, at step S201, reads from the user print setting information storage unit 19 the user print setting information stored therein input via the print setting screen 11 before the print job is set. For example, in a case where user print setting information such as that of the print setting screen 11 of FIG. 3 is set, the print setting information comparison unit 15 retrieves, as the user print setting information, user print setting information wherein the number of copies setting is one copy, the color setting is black and white, the number of pages per sheet setting is two pages per sheet, the double-sided printing setting is off, and the enlarging or shrinking setting iS200%.

The print setting information comparison unit 15 reads the print setting information and, at step S202, compares the print setting information acquired from the print setting information acquisition unit 13 and the user print setting information read from the user print setting information storage unit 12.

In a case where a result of the comparison by the print setting information comparison unit 15 at step S202 is that the print setting information and the user print setting information are the same, the print setting information comparison unit 15, at step S203, makes a judgment to initiate printing, thereby finishing the comparison process. The print setting information comparison unit 15 then sends the print job to the printing data generation unit 16 so that the printing data can be generated based on the received print job.

On the other hand, in a case where a result of the comparison by the print setting information comparison unit 15 at step S202 is that the print setting information and the user print setting information are not the same, the print setting information comparison unit 15, at step S204, sends the print setting information and the user print setting information to the confirmation screen display unit 18 and requests execution of the display process of the confirmation screen. Then, at step S205, the print setting information comparison unit 15 stands by until receiving a response from the confirmation screen display unit 18.

In the manner described above, where the print setting information comparison unit 15 requests performance of the display process of the confirmation screen in the confirmation screen display unit 18, the confirmation screen display unit 18 performs the display process of the confirmation screen according to the steps shown in FIG. 6.

Upon receiving the request for the display process of the confirmation screen from the print setting information comparison unit 15, the confirmation screen display unit 18, at step S210, compares the print setting information received from the print setting information comparison unit and the user print setting information. At this time, the confirmation screen display unit 18 compares the fields of the print setting information to the corresponding fields of the user print setting information and retrieves the fields that are different.

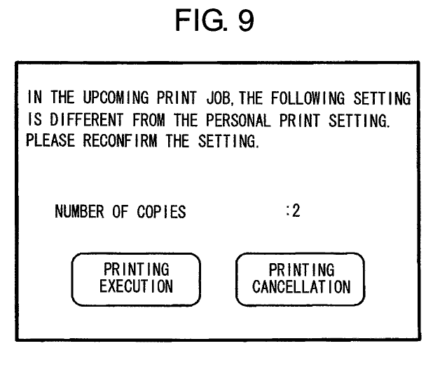

Next, at step S211, the confirmation screen display unit 18 displays in the display of the image processing apparatus 1 the notification that there is a difference between the print setting information and the user print setting information and also the field having the difference retrieved at step S210 from among the fields of the received print setting information, resulting in the confirmation screen shown in FIG. 9. In the example of the confirmation screen displaying only the field having a difference and the information of the field shown in FIG. 9, only the number of copies setting, which is the field having the difference, and the information of the field, which is two copies, is displayed, and neither other fields nor the information of the other fields is displayed.

At step S212, the confirmation screen display unit 18 stands by until the user presses one of either the printing execution button or the printing cancellation button to issue a response regarding the print job. After receiving a response from the user, the confirmation screen display unit 18, at step S213, makes a judgment as to whether the printing execution button is pushed.

At step S213, in a case where the printing execution button is pushed, the confirmation screen display unit 18, at step S214, notifies the print setting information comparison unit 15 of a response to initiate printing, thereby finishing the display process. On the other hand, in a case where the printing cancellation button is pushed at step S213, the confirmation screen display unit 18, at step S215, notifies the print setting information comparison unit 15 of a response to cancel printing, thereby finishing the display process.

As shown in step S205 of FIG. 7, upon receiving notification of the response from the confirmation screen display unit 18, the print setting information comparison unit 15, at step S206, makes a judgment as to whether the notification is the response to initiate printing.

In a case where the result of the judgment at step S206 is that the print setting information comparison unit 15 receives notification of the response to initiate printing, the print setting information comparison unit 15, at step S203, makes a judgment to initiate printing, thereby finishing the comparison process. The print setting information comparison unit 15 then sends the print job to the printing data generation unit 16 to generate the printing data based on the received print job.

On the other hand, in a case where the result of the judgment at step S206 is that the print setting information comparison unit 15 receives notification of the response to cancel printing, the print setting information comparison unit 15, at step S207, makes a judgment to cancel printing and deletes the print job, thereby finishing the comparison process.

In the manner described above, the image processing apparatus 1 described as the second embodiment can compare the print setting information and the user print setting information and retrieve the fields having a difference through the confirmation screen display unit 18. Furthermore, the user can more easily understand the confirmed fields because the field having a difference and the information of the field having the difference are displayed in the confirmation screen, along with notification that there is a difference between the print setting data and the user print setting data.

### Third Embodiment

The image processing apparatus 1 described in a third embodiment has the same structure as that of the second embodiment, but the display process by the confirmation screen display unit 18 is different in that, along with notification that there is a difference between the print setting information and the user print setting information, a field of the print setting information that is different is displayed in an emphasized manner. In addition, because the image processing apparatus 1 described in the third embodiment has the same structure as that of the second embodiment, the same numerals are used for the same parts and the description is omitted.

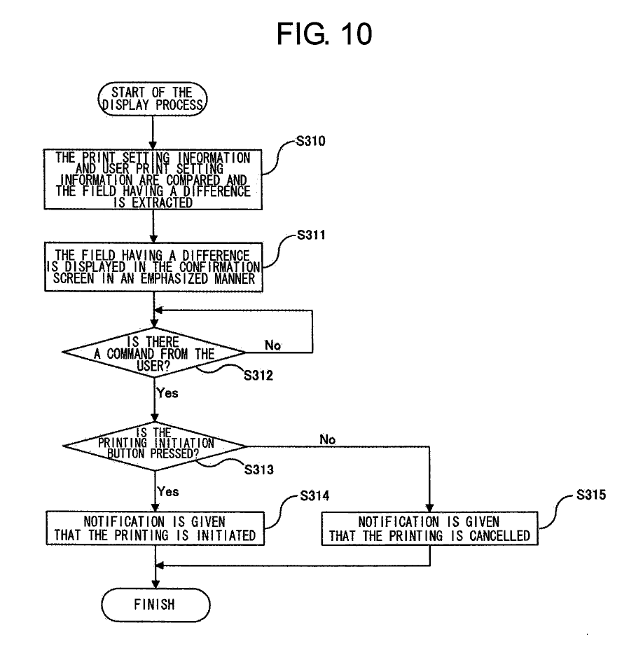

The display process of the confirmation screen by the confirmation screen display unit 18 in the image processing apparatus 1 described in the third embodiment is described referencing FIG. 10. FIG. 10 is a flow chart of the display process of the confirmation screen by the confirmation screen display unit.

In the same manner as the second embodiment, upon receiving the print job, the print setting information comparison unit 15 performs the comparison process between the print setting information and the user print setting information according to the steps shown in FIG. 7. The comparison process is the same as that of the second embodiment, and therefore the description is omitted.

In the manner described above, where the print setting information comparison unit 15 requests performance of the display process of the confirmation screen in the confirmation screen display unit 18, the confirmation screen display unit 18 performs the display process of the confirmation screen according to the steps shown in FIG. 10.

Upon receiving the request for the display process of the confirmation screen from the print setting information comparison unit 15, the confirmation screen display unit 18, at step S310, compares the print setting information received from the print setting information comparison unit and the user print setting information. At this time, the confirmation screen display unit 18 compares the fields of the print setting information to the corresponding fields of the user print setting information and retrieves the fields that are different.

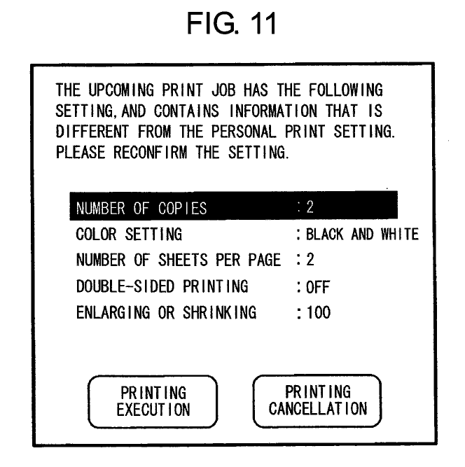

Next, at step S311, the confirmation screen display unit 18 displays in the display of the image processing apparatus 1 the notification that there is a difference between the print setting information and the user print setting information and also displays in an emphasized manner the field having the difference retrieved at step S310 from among the fields of the received print setting information and the information of this field, resulting in the confirmation screen shown in FIG. 11. In the example of the confirmation screen displaying in an emphasized manner the field having a difference and the information of the field shown in FIG. 11, only the number of copies setting, which is the field having the difference, and the information of the field, which is two copies, are displayed as outlined characters, but other fields and the information of the other fields is displayed in a normal manner.

At step S312, the confirmation screen display unit 18 stands by until the user presses one of either the printing execution button or the printing cancellation button to issue a response regarding the print job. After receiving a response from the user, the confirmation screen display unit 18, at step S313, makes a judgment as to whether the printing execution button is pushed.

At step S313, in a case where the printing execution button is pushed, the confirmation screen display unit 18, at step S314, notifies the print setting information comparison unit 15 of a response to initiate printing, thereby finishing the display process. On the other hand, in a case where the printing cancellation button is pushed at step S313, the confirmation screen display unit 18, at step S315, notifies the print setting information comparison unit 15 of a response to cancel printing, thereby finishing the display process.

Upon receiving notification of the response from the confirmation screen display unit 18, the print setting information comparison unit 15 continues the comparison process shown in FIG. 7 and described in the second embodiment.

In the manner described above, the image processing apparatus 1 described as the third embodiment can compare the print setting information and the user print setting information and retrieve the fields having a difference through the confirmation screen display unit 18. Furthermore, the user can more easily understand the confirmed fields because the field having a difference and the information of the field having the difference are displayed in an emphasized manner in the confirmation screen, along with notification that there is a difference between the print setting data and the user print setting data.

### Fourth Embodiment

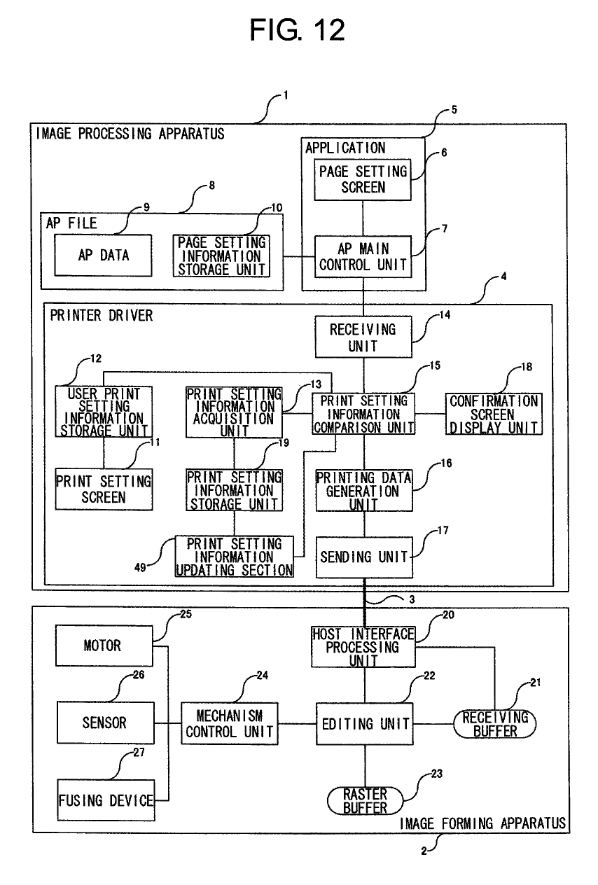

As shown in FIG. 12, the image processing apparatus 1 described as a fourth embodiment has the same structure as the first embodiment, and is further provided with a print setting information updating section 49. The following is a description of the image processing apparatus 1 described in the fourth embodiment, wherein parts which are the same as those of the first embodiment are given the same numerals and the description is omitted.

The print setting information comparison unit 15 compares the user print setting information stored in the user print setting information storage unit 12 and the print setting information stored in the print setting information storage unit 19 and, in a case where there is a difference between the user print setting information and the print setting information, acquires the setting selectable for each field of the print setting screen 11 as selectable information.

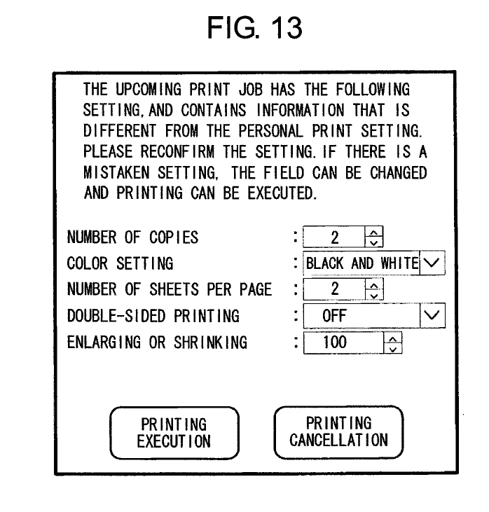

The confirmation screen display unit 18 displays in the display of the image processing apparatus 1 a confirmation screen such as that shown in FIG. 13, for example, and provides notification that there is a difference between the user print setting information and the print setting information. The print setting information is then displayed in the confirmation screen at a default value immediately after the confirmation screen is displayed. The print setting information displayed in the confirmation screen is selected from among the selectable information acquired by the print setting information comparison unit 15, and furthermore, the print setting information can be updated and the selected selectable information is displayed in the confirmation screen. The printing execution button of the confirmation screen performs printing based on new print setting information having new selectable information for each field displayed in the confirmation screen. Furthermore, by pressing the printing cancellation button of the confirmation screen, printing based on the print job having the new print setting information is cancelled.

In the print setting information updating section 49, by pressing the printing execution button, the print setting information is updated to the new print setting information set via the confirmation screen display unit 18. For example, in a case where the number of copies setting is changed from two copies to one copy in the confirmation screen, the print setting information updating section 49 sets new print setting information in which the number of copies setting is one copy. At this time, the print setting information updating section 49 stores the print setting information before the change in the print setting information storage unit 19 to update the print setting information to the new print setting information. The new print setting information and the print job are then sent to the printing data generation unit 16 to generate the printing data.

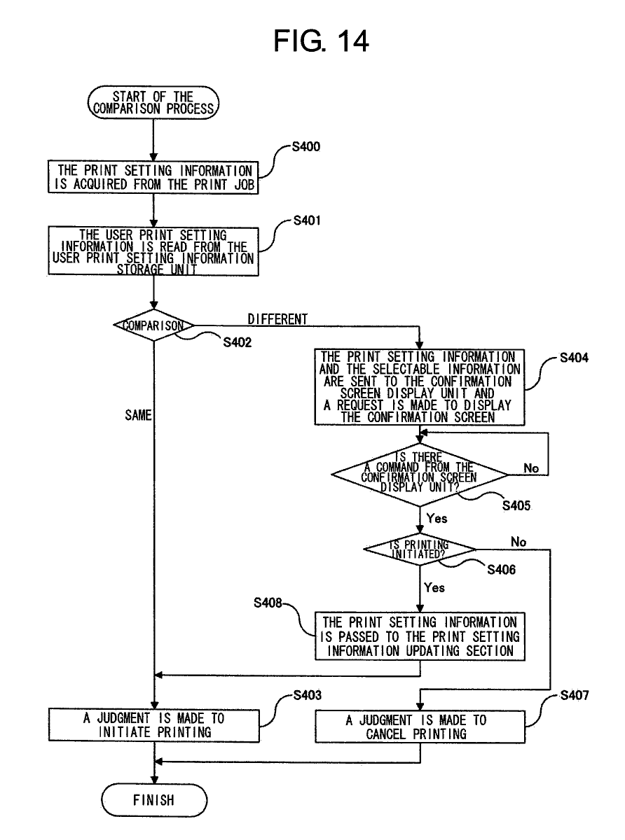

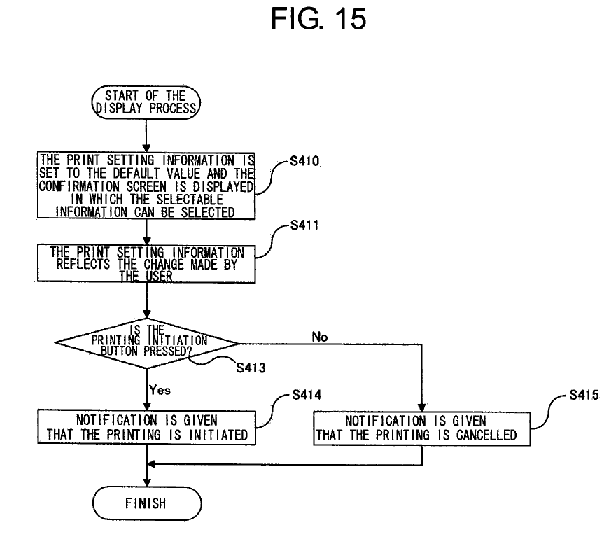

The image processing apparatus having the aforementioned structure performs in the same manner as the first embodiment. Next, the comparison process of the print setting information by the print setting information comparison unit 15 and the display process of the confirmation screen by the confirmation screen display unit 18 are described referencing FIG. 14 and FIG. 15. FIG. 14 is a flow chart of the comparison process between the print setting information and the user print setting information by the print setting information comparison unit. FIG. 6 is a flow chart of the display process of the confirmation screen by the confirmation screen display unit.

In the same manner as the first embodiment, the print setting information comparison unit 15, upon receiving the print job, performs the comparison process between the print setting information and the user print setting information according to the steps shown in FIG. 14.

The print setting information comparison unit 15 sends the received print job to the print setting information acquisition unit 13. The print setting information acquisition unit 13 retrieves the print setting information from the received print job. For example, in a case where print setting information such as that of the page setting screen 6 of FIG. 2 is set, the print setting information acquisition unit 13 retrieves, as the print setting information, print setting information wherein the number of copies setting is two copies, the color setting is black and white, the number of pages per sheet setting is two pages per sheet, the double-sided printing setting is off, and the enlarging or shrinking setting is 100%. The print setting information acquisition unit 13 stores the retrieved print setting information in the print setting information storage unit 19. The print setting information acquisition unit 13 then sends the print setting information stored in the print setting information storage unit 19 to the print setting information comparison unit 15. The print setting information comparison unit 15, at step S400, acquires the print setting information from the print setting information acquisition unit 13.

The print setting information comparison unit 15 receives the print setting information and, at step S401, reads from the user print setting information storage unit 19 the user print setting information stored therein input via the print setting screen 11 before the print job is set. For example, in a case where user print setting information such as that of the print setting screen 11 of FIG. 3 is set, the print setting information comparison unit 15 retrieves, as the user print setting information, user print setting information wherein the number of copies setting is one copy, the color setting is black and white, the number of pages per sheet setting is two pages per sheet, the double-sided printing setting is off, and the enlarging or shrinking setting iS400%.

The print setting information comparison unit 15 reads the print setting information and, at step S402, compares the print setting information acquired from the print setting information acquisition unit 13 and the user print setting information read from the user print setting information storage unit 12.

In a case where a result of the comparison by the print setting information comparison unit 15 at step S402 is that the print setting information and the user print setting information are the same, the print setting information comparison unit 15, at step S403, makes a judgment to initiate printing, thereby finishing the comparison process. The print setting information comparison unit 15 then sends the print job to the printing data generation unit 16 so that the printing data can be generated based on the received print job.

On the other hand, in a case where a result of the comparison by the print setting information comparison unit 15 at step S402 is that the print setting information and the user print setting information are not the same, the print setting information comparison unit 15 acquires the setting selectable for each field of the print setting screen 11 as selectable information. Then, at step S404, the print setting information comparison unit 15 sends the print setting information and the selectable information to the confirmation screen display unit 18 and requests execution of the display process of the confirmation screen. Then, at step S405, the print setting information comparison unit 15 stands by until receiving a response from the confirmation screen display unit 18.

In the manner described above, where the print setting information comparison unit 15 requests performance of the display process of the confirmation screen in the confirmation screen display unit 18, the confirmation screen display unit 18 performs the display process of the confirmation screen according to the steps shown in FIG. 15.

Upon receiving the request for the display process of the confirmation screen from the print setting information comparison unit 15, the confirmation screen display unit 18 displays notification that there is a difference between the print setting information and the user print setting information. Then, at step S410, the confirmation screen display unit 18 sets the print setting information to the default value and displays the confirmation screen such as that shown in FIG. 13 having selectable information that is selectable in the display of the image processing apparatus 1.

The confirmation screen display unit 18 monitors the change of the default print setting information displayed in the confirmation screen by the user. Then, at step S411, the confirmation screen display unit 18 reflects the change made by the user in the confirmation screen.

The confirmation screen display unit 18 then stands by until the user presses one of either the printing execution button or the printing cancellation button to give a response concerning the print job. After receiving the response of the user, the confirmation screen display unit 18, at step S413, makes a judgment as to whether the printing execution button is pressed.

At step S413, in a case where the printing execution button is pushed, the confirmation screen display unit 18, at step S414, sends to the print setting information comparison unit 15 the selectable information selected for each field in the confirmation screen as the new imprint setting information and notifies the print setting information comparison unit 15 of a response to initiate printing, thereby finishing the display process. On the other hand, in a case where the printing cancellation button is pushed at step S413, the confirmation screen display unit 18, at step S415, notifies the print setting information comparison unit 15 of a response to cancel printing, thereby finishing the display process.

As shown in step S405 of FIG. 14, upon receiving notification of the response from the confirmation screen display unit 18, the print setting information comparison unit 15, at step S406, makes a judgment as to whether the notification is the response to initiate printing.

In a case where the result of the judgment at step S406 is that the print setting information comparison unit 15 receives notification of the response to initiate printing, the print setting information comparison unit 15, at step S408, sends the received new print setting information and notification of the printing initiation response to the print setting information updating section 49. The print setting information updating section 49 receives the new print setting information, sets the new print setting information as the print setting information of the print job, and updates the unchanged print setting information of the print setting information storage unit 19.

The print setting information comparison unit 15 then, at step S403, makes a judgment to initiate printing, thereby finishing the comparison process. The print setting information comparison unit 15 then sends the print job having the new print setting information to the printing data generation unit 16 to generate the printing data based on the received print job.

On the other hand, in a case where the result of the judgment at step S406 is that the print setting information comparison unit 15 receives notification of the response to cancel printing, the print setting information comparison unit 15, at step S407, makes a judgment to cancel printing and deletes the print job, thereby finishing the comparison process.

In the manner described above, the image processing apparatus 1 described as the fourth embodiment can compare the user print setting information and the print setting information through the print setting information comparison unit 15 and, in a case where a judgment is made that there is a difference, can display in a confirmation screen notification that there is a difference between the user print setting information and the print setting information through the confirmation screen display unit 18. Furthermore, by making it possible to change the print setting information in the confirmation screen, the unchanged print setting information can be updated to the new print setting information, which is changed in the confirmation screen, by the print setting information updating section 49. Therefore, it is not necessary for the user to fix the setting of the print setting information from the beginning to execute printing.

The image processing apparatus 1 according to the present invention, in a case where there is a difference between the print setting information and the user print setting information set by each user which are associated with the print job, displays to the user notification that there is a difference between the print setting information and the user print setting information. The present invention is not limited to this, however, and, in a case where a creator of the print job created by the application is contained in the print setting information and a user name is contained in the user print setting information, a judgment is made that there is a difference between the creator and the user name and notification that there is a difference between the creator and the user name is displayed in the confirmation screen.

In the image processing apparatus 1 according to the present invention, notification of the print setting information associated with the print job is displayed, but both the print setting information associated with the print job and the user print setting information set for each user may be displayed in the confirmation screen.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An image processing apparatus generating printing data based on a received print job, comprising:
a user print setting information input section for inputting user print setting information set for each user;
a user print setting information storage section for storing the user print setting information input by said user print setting information input section;
a print setting information acquisition section for acquiring the print setting information from the print job;
a print setting information comparison section for making a comparison between the user print setting information stored in said user print setting information storage section and the print setting information acquired by said print setting information acquisition section; and
a display section for displaying notification that there is a difference between the user print setting information and the print setting information in a case where a result of the comparison by said print setting information comparison section is that there is a difference between the user print setting information and the print setting information.

2. The image processing apparatus according to claim 1, wherein:
said display section receives the print setting information from said print setting information comparison section,
said display section displays notification that there is a difference between the user print setting information and the print setting information; and
said display section displays the print setting information received from said print setting information comparison section.

3. The image processing apparatus according to claim 2, wherein:
said display section receives the user print setting information from said print setting information comparison section;
said display section retrieves a field, which is different from the field of the user print setting information received from said print setting information comparison section, from among the fields of the print setting information received from the print setting information comparison section; and
said display section displays the retrieved print setting information in an emphasized manner.

4. The image processing apparatus according to claim 2, comprising a print setting information updating section for updating the print setting information of the print job to new print setting information, and wherein:
said display section can change the displayed print setting information; and
said print setting information updating section updates the print setting information changed by said display section to the new print setting information.

5. The image processing apparatus according to claim 1, wherein:
said display section receives the user print setting information and the print setting information from the print setting information comparison section;
said display section retrieves a field, which is different from the field of the user print setting information received from said print setting information comparison section, from among the fields of the print setting information received from the print setting information comparison section; and
said display section displays notification that there is a difference between the user print setting information and the print setting information, and also displays only the retrieved field of the print setting information.

6. The image processing apparatus according to claim 5, wherein said display section displays the retrieved print setting information in an emphasized manner.

7. The image processing apparatus according to claim 5, comprising a print setting information updating section for updating the print setting information of the print job to new print setting information, and wherein:
said display section can change the displayed print setting information; and
said print setting information updating section updates the print setting information changed by said display section to the new print setting information.
